(19) United States
(12) Patent Application Publication
(10) Pub. No.: US 2026/0273454 A1
(43) Pub. Date: Sep. 17, 2026

(54) MESH-SHAPED POROUS CO2-CAPTURING SOLUTION AND SEPARATION METHOD FOR CO2 GAS

(71) Applicants: China University of Petroleum-Beijing, Beijing City (CN); BASEMOF TECHNOLOGY CO., LTD., Beijing (CN)

(72) Inventors: Guangjin CHEN, Beijing City (CN); Han TANG, Beijing City (CN); Peng XIAO, Beijing City (CN); Changyu SUN, Beijing City (CN); Ziying ZHAO, Beijing (CN); Qun LI, Beijing City (CN); Jin CAI, Beijing City (CN); Guodong LI, Beijing City (CN); Haihang QIN, Beijing City (CN)

(73) Assignees: China University of Petroleum-Beijing, Beijing City (CN); BASEMOF TECHNOLOGY CO., LTD., Beijing (CN)

(21) Appl. No.: 19/473,126

(22) PCT Filed: Nov. 13, 2024
(86) PCT No.: PCT/CN2024/131701

§ 371 Date: Oct. 6, 2025

(30) Foreign Application Priority Data
Nov. 16, 2023 (CN) 202311531568.1

(51) Int. Cl. B01D 53/14

(52) U.S. Cl. CPC B01D 53/1493; B01D 53/1425; B01D 53/1475; B01D 2252/20478; B01D 2252/205

(57) ABSTRACT

There are a mesh-shaped porous CO₂-capturing solution and a separation method for CO₂ gas. The composition of the capturing solution has 1%-50% of a specific chemical agent and 50%-99% of water. The specific chemical agent is one or a combination of two or more of an imidazole substance, an imidazole ionic liquid, a piperazine substance, and an amino alcohol substance. The mesh-shaped porous CO₂-capturing solution remains stable and adsorbs CO₂ at low temperatures. The porous structure disintegrates and releases CO₂ at high temperatures. The mesh-shaped porous CO₂-capturing solution has advantages, including fast absorption rate, a large absorption capacity, and a low regeneration temperature.

### CROSS-REFERENCE TO RELATED APPLICATIONS

The present application is a National Stage of International Application No. PCT/CN2024/131701, filed on Nov. 13, 2024 and entitled MESH-SHAPED POROUS CO₂-CAPTURING SOLUTION AND SEPARATION METHOD FOR CO₂ GAS, which claims priority to Chinese Patent Application No. 202311531568.1, filed on Nov. 16, 2023, both of which are hereby incorporated by reference in their entireties.

### FIELD OF THE DISCLOSURE

The present disclosure relates to a mesh-shaped porous CO₂-capturing solution and a method for separating CO₂ gas, and belongs to the technical field of chemical separation.

### DESCRIPTION OF THE RELATED ART

CO₂ capture, utilization, and storage (CCUS) technology is considered to be one of the key strategies for mitigating the greenhouse effect. Currently, there are various carbon capture technologies available, mainly including physical absorption method, chemical absorption method, adsorption method, membrane separation method, cryogenic separation method, and the like. However, these technologies intrinsically have the following limitations, for example, the chemical absorption method suffers from disadvantages such as degradability of solvents, high corrosivity, and high energy consumption for regeneration of solvents; the membrane separation method has low processing capacity and poor stability; and the cryogenic separation method is excessively reliant on temperature and requires high energy input.

The alcohol amine method is the most widely applied CO₂-capturing method, but it also has problems such as high energy consumption for regeneration and solvent degradation. Therefore, it is of critical importance to develop a CO₂-capturing method with low energy consumption and high efficiency. Since a single absorbent is unlikely to simultaneously meet the requirements of large absorption capacity, fast absorption rate, and low reaction heat, one of the current research focuses is to mix multiple absorbents in order to obtain a novel absorbent that has high absorption rate, large absorption capacity, and low energy consumption for regeneration.

### SUMMARY OF THE DISCLOSURE

To address the above technical problems, an object of the present disclosure is to provide a mesh-shaped porous CO₂-capturing solution.

A further object of the present disclosure is to provide a method for separating CO₂ gas.

To achieve the above objects, the present disclosure provides a mesh-shaped porous CO₂-capturing solution, comprising 1%-50% of a specific chemical agent, and 50%-99% of water, with respect to 100% of the total mass of the capturing solution;

wherein the specific chemical agent is one or a combination of two or more of an imidazole-based substance, an imidazole-based ionic liquid, a piperazine-based substance, and an alcohol amine-based substance.

The mesh-shaped porous CO₂-capturing solution provided by the present disclosure is formed by self-assembly of molecules after water and the specific chemical agent are mixed, where the specific chemical agent is capable of forming a mesh-shaped porous structure. Such mesh-shaped porous CO₂-capturing solution is stable and can adsorb CO₂ at low temperatures (0° C.-50° C.), where CO₂ can be stably adsorbed within the porous structure, while the porous structure is gradually disintegrated and the adsorbed CO₂ is released at high temperatures (60° C. or higher).

In the above capturing solution, preferably, the specific chemical agent forms a mesh-shaped porous structure in water.

In the above capturing solution, preferably, the imidazole-based substance includes one or a combination of two or more of imidazole, 2-methyl imidazole, 1-methyl imidazole, 2-ethyl imidazole, 1,2-dimethyl imidazole, 2-ethyl-4-methyl imidazole, and 2-phenylimidazole.

In the above capturing solution, preferably, the imidazole ionic-based liquid includes one or a combination of two or more of 1-butyl-3-methyl imidazolium tetrafluoroborate [BMIM][BF₄], 1-hexyl-3-methyl imidazolium tetrafluoroborate [HMIM][BF₄], 1-hexyl-3-methyl imidazolium hexafluorophosphate [HMIM][PF₆], 1-ethyl-3-methyl imidazolium chloride [EMIM][Cl], and 1-ethyl-3-methyl imidazolium bis(trifluoromethanesulfonyl)imide [EMIM][TF₂N].

In the above capturing solution, preferably, the piperazine-based substance includes one or a combination of two or more of piperazine (PZ), 1-(2-aminoethyl) piperazine (AEP), N-(2-hydroxyethyl) piperazine (HEPZ), 1-methyl piperazine (1-MPZ), and 2-methyl piperazine (2-MPZ).

In the above capturing solution, preferably, the alcohol amine-based substance includes one or a combination of two or more of diethanolamine (DEA), N-methyl diethanolamine (MDEA), 2-amino-2-methyl-1-propanol (AMP), hydroxyethyl ethylenediamine (AEEA), diethylenetriamine (DETA), N-methyl cyclohexylamine (MCA), and triethanolamine (TEA).

According to a specific embodiment of the present disclosure, the method for preparing the above mesh-shaped porous CO₂-capturing solution includes a step of mixing the specific chemical agent with water, and stirring uniformly to yield a dispersed and stable liquid.

The present disclosure further provides a method for separating CO₂ gas, which includes capturing CO₂ by utilizing the above mesh-shaped porous CO₂-capturing solution.

According to a specific embodiment of the present disclosure, preferably, the separation method achieves the separation of CO₂ from a mixed gas of CO₂ and N₂.

In the above separation method, preferably, CO₂ is captured at an absorption temperature of 0° C. to 50° C.

In the above separation method, preferably, CO₂ is captured at an absorption pressure of 0.1 MPa to 1 MPa.

In the above separation method, preferably, the method further includes a step of desorbing a CO₂-rich solution, which is obtained after CO₂ is captured, under vacuum and heating conditions, followed by regenerating a lean solution for reuse. The heating temperature is preferably 60° C.-100° C.; the vacuum preferably has an absolute pressure of 80 kPa or less.

The mesh-shaped porous CO₂-capturing solution of the present disclosure can remain stable and adsorb CO₂ at low temperatures (0° C.-50° C.) and gradually disintegrate the porous structure and release the adsorbed CO₂ at high temperatures (60° C. or higher). Such capturing solution also has advantages of fast absorption rate, large absorption capacity, low desorption heat, low regeneration temperature, and resistance to degradation simultaneously, thereby offering broad application prospects in carbon capture and CO₂ utilization fields.

### BRIEF DESCRIPTION OF THE DRAWINGS

FIG. 1 is a graph of evaluation of CO₂ solubility and absorption rate in Example 1.

FIG. 2 is a graph of evaluation of CO₂ solubility, absorption rate, and desorption heat in Example 2.

FIG. 3 is a result of thermodynamic and kinetic experiment of CO₂ absorption for the regenerated solution in Example 3.

FIG. 4 is a cryo-electron microscopy image of the mesh-shaped porous CO₂-capturing solution of the present disclosure, where (a) for absorbent I; (b) for absorbent V; (c) for absorbent VIII; and (d) for absorbent II.

FIG. 5 is a schematic diagram of the pilot-scale CO₂/N₂ continuous separation device in Example 5.

### DESCRIPTION OF REFERENCE NUMERALS

501 CO₂ cylinder
502 Air compressor
503 Gas buffering tank
504 Infrared CO₂ monitor at inlet of absorption column
505 Infrared CO₂ monitor at outlet of absorption column
506 Liquid ring vacuum pump
507 Absorption column
508 Desorption column
509 Centrifugal pump
510 Liquid filling tank
511 Temperature sensor
512 Mass flow meter
513 Metering pump
514 Pressure transmitter
515 Mixer
516 Liquid buffering tank

### DETAILED DESCRIPTION OF EMBODIMENTS

To facilitate a clearer understanding of the technical features, objects, and beneficial effects of the present disclosure, the technical solution of the present disclosure is described below in detail. However, this should not be construed as limiting the implementable scope of the present disclosure.

The test apparatus of the present disclosure is the apparatus described in ZL201910327202.X, and is used for thermodynamic and kinetic experiments of pure gases and gas mixtures. The data processing procedures for relevant gas solubility experiments and separation experiments can be found in paragraphs 0030-0048 of the specification of ZL201910327202.X (CN111821812A).

### Example 1

The example provided a set of mesh-shaped CO₂-capturing solutions, which were absorbent I, absorbent II, absorbent III, and absorbent IV, respectively.

Herein, with respect to 100% of the total mass of the solution, the composition of the absorbent I is (30% of 2-ethyl imidazole+a balance of water); the composition of the absorbent II is (30% of imidazole+a balance of water); the composition of the absorbent III is (30% of MDEA+a balance of water); and the composition of the absorbent IV is (30% of 2-methyl imidazole+a balance of water).

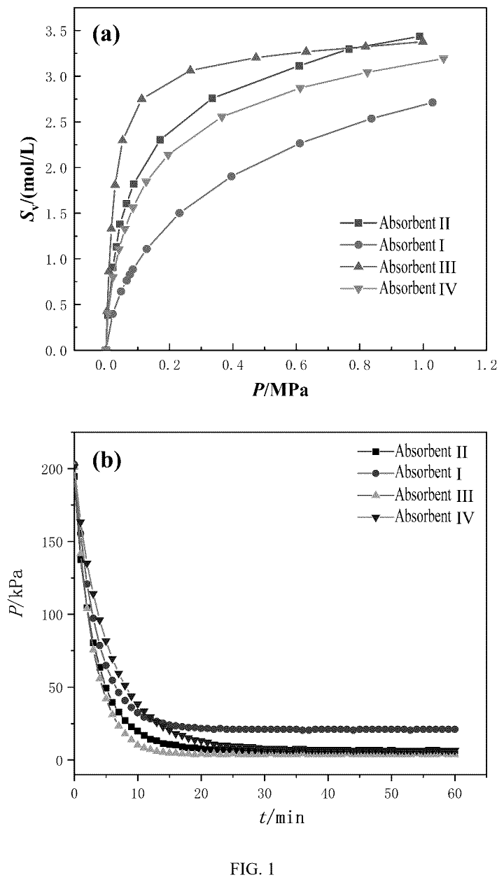

At an absorption temperature of 30° C., pure CO₂ gas was used as the feed gas to test the absorption capacity (CO₂ solubility) and absorption rate for each absorbent, and the results were shown in FIG. 1, where (a) is the test result of the absorption capacity, and (b) is the test result of the absorption rate, in which the horizontal coordinate denotes an absorption pressure, and the vertical coordinate denotes the value of the absorption amount at the corresponding pressure.

### Example 2

The example provided a set of mesh-shaped CO₂-capturing solutions, which were absorbent V and absorbent VI, respectively.

Herein, with respect to 100% of the total mass of the solution, the composition of the absorbent V is (30% of imidazole+5% of AEP+a balance of water); and the composition of the absorbent VI is (30% of imidazole+5% of DEA+a balance of water).

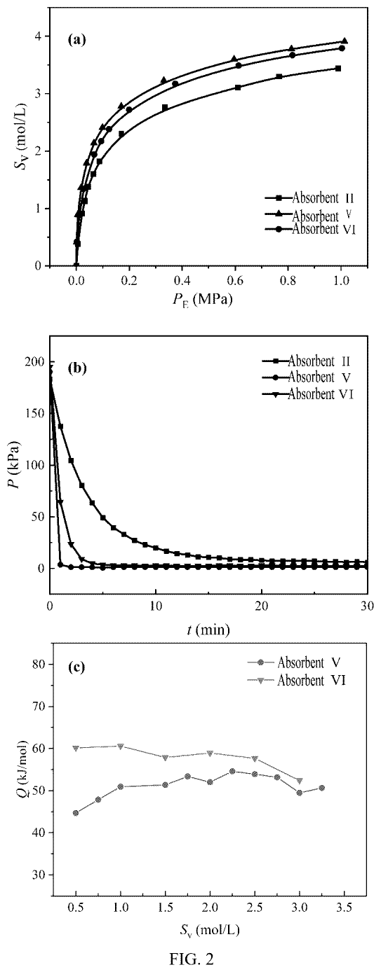

At an absorption temperature of 30° C., pure CO₂ gas was used as the feed gas to test the absorption capacity (CO₂ solubility), absorption rate, and desorption heat for absorbent II, absorbent V, and absorbent VI, and the results were shown in Table 1 and FIG. 2, where (a) is the test result of the absorption capacity, and (b) is the test result of the absorption rate, and (c) is a graph of evaluation of the desorption heat of CO₂ in absorbent V and absorbent VI.

TABLE 1
Average absorption heat of various absorbents

| Loading amount (mol/L) | Absorbent V (kJ/mol) | Absorbent VI (kJ/mol) |
|---|---|---|
| 0.5 | 44.6739 | 60.1435 |
| 0.75 | 47.829 | |
| 1 | 50.9073 | 60.5577 |
| 1.5 | 51.3267 | 57.8754 |
| 1.75 | 53.3489 | |
| 2 | 51.9807 | 58.9192 |
| 2.25 | 54.5769 | |
| 2.5 | 53.8807 | 57.6560 |
| 2.75 | 53.1415 | |
| 3 | 49.4525 | 52.3946 |
| 3.25 | 50.6140 | |

From the test results shown in Table 1 and FIG. 2, it can be seen that when the equilibrium pressure (PE) is 1 MPa, the absorption amount of the blended absorbent system was increased by 13.93% and 10.42%, respectively, compared to the aqueous solutions of a single absorbent. Furthermore, considering the absorption kinetics of the blended solution for CO₂, when the inlet pressure is 200 kPa, the absorption rate of the blended solution system (i.e., the absorption amount of the system per unit time) was increased by 10 times and 4 times, respectively, compared to absorbent II. This indicates that the blended absorbent significantly improves both the absorption amount and the absorption rate of CO₂.

### Example 3

To verify whether the absorbent in Example 2 can be reused for CO₂ capture, pure CO₂ gas was used as the feed gas, and multiple CO₂ absorption-desorption operations were performed with the above absorbent V to assess its reusability.

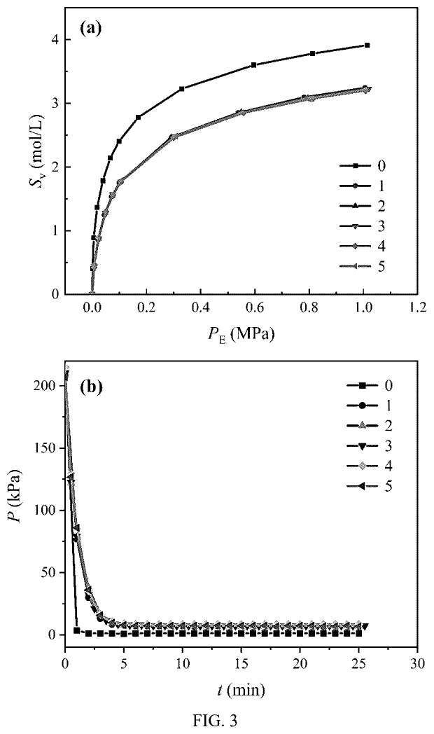

After the CO₂ absorption experiment was completed, the rich solution was desorbed at a temperature of 80° C. and a desorption pressure of 80 kPa for 30 min. The resulting lean solution was further used for CO₂ capture experiments, and the results were shown in FIG. 3, where (a) is the test result of the absorption capacity, and (b) is the test result of the absorption rate.

Under such desorption conditions, after the test of multiple absorption-desorption cycles, the separation performance of absorbent V showed a slight decrease compared to that of a fresh solution, whereas after the second regeneration, the absorption capacity and absorption rate tended to be stable, and no significant decrease occurred after multiple cycles and reuse, demonstrating an excellent reusing performance.

### Example 4

The example provided a set of mesh-shaped CO₂-capturing solutions, which were absorbent VII, absorbent VIII, and absorbent IX, respectively.

Herein, with respect to 100% of the total mass of the solution, the composition of the absorbent VII is (30% of [BMIM][BF₄]+a balance of water); the composition of the absorbent VIII is (20% of [BMIM][BF₄]+10% of imidazole+a balance of water); and the composition of the absorbent IX is (20% of [BMIM][BF₄]+10% of AEP+a balance of water).

At an absorption temperature of 40° C., pure CO₂ gas was used as the feed gas to test the CO₂ absorption amount for absorbent VII, absorbent VIII, and absorbent IX, and the results were shown in Table 2.

TABLE 2
Test result of absorption amount for different absorbents

| Temperature | Pressure | | Absorption |
|---|---|---|---|
| (° C.) | (MPa) | Absorbent | amount (mol/mol) |
| 40 | 3 | Absorbent VII | 0.53 |
| 40 | 3 | Absorbent VIII | 0.78 |
| 40 | 3 | Absorbent IX | 0.81 |

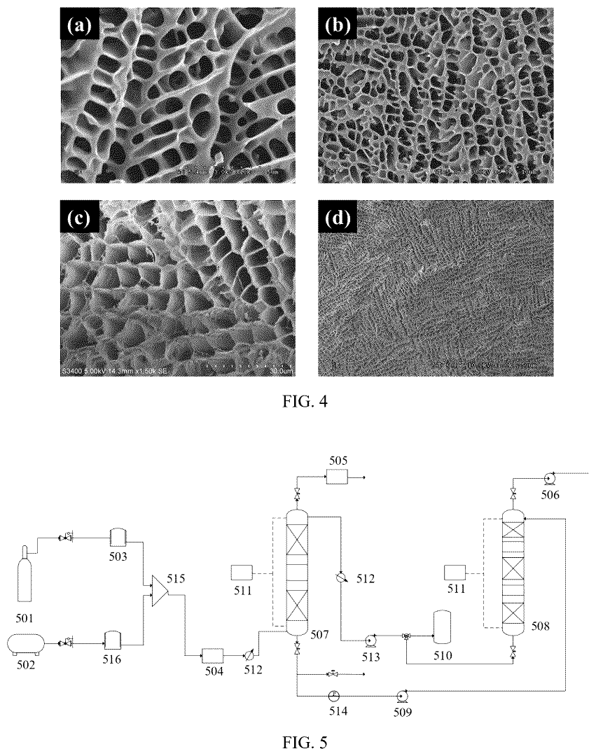

FIG. 4 is a cryo-electron microscopy image of the mesh-shaped porous CO₂-capturing solution of the present disclosure, where (a) for absorbent I; (b) for absorbent V; (c) for absorbent VIII; and (d) for absorbent II. From the cryo-electron microscopy image, it can be seen that each absorbent has formed a mesh-shaped porous structure.

### Example 5

The example provided a method for separating CO₂ gas, which achieved continuous separation of CO₂/N₂.

First, a blended solution having a mass fraction of 33%, containing 30% of imidazole and 3% of 1-(2-aminoethyl) piperazine with the balance being water, was prepared.

The absorbent was used as the separation medium for continuous separation experiments. FIG. 5 is a schematic flow diagram of continuous carbon capture with the capturing solution.

The apparatus included a CO₂ cylinder 501, an air compressor 502, a gas buffering tank 503, an infrared CO₂ monitor 504 at the inlet of an absorption column, an infrared CO₂ monitor 505 at the outlet of an absorption column, a liquid ring vacuum pump 506, an absorption column 507, a desorption column 508, a centrifugal pump 509, a liquid filling tank 510, a temperature sensor 511, a mass flow meter 512, a metering pump 513, a pressure transmitter 514, a mixer 515, and a liquid buffering tank 516.

Among these, the CO₂ cylinder 501 and the air compressor 502 were used to supply the feed gases, and both of them converged to a single pipeline through the mixer 515 and were connected to the inlet of the bottom of the absorption column 507. Additionally, a check valve and the gas buffering tank 503 were provided between the CO₂ cylinder 501 and the mixer 515; a pressure reducing valve and the liquid buffering tank 516 were provided between the air compressor 502 and the mixer 515; and the infrared CO₂ monitor 504 at the inlet of the absorption column as well as the mass flow meter 512 were provided between the mixer 515 and the inlet of the bottom of the absorption column 507; wherein the check valve was used to control the flow direction of the feed gases and prevent backflow; the pressure reducing valve was used to control the pressure of the feed gases; the infrared CO₂ monitor 504 at the inlet of the absorption column was used to monitor CO₂ concentration in the mixed gas entering the absorption column; the mass flow meter 512 was used to meter the amount of the gas entering the absorption column 507 and to control parameters such as flow rate;

The absorption column 507 has an inner diameter of 66 mm, a packing height of 2.5 m, and a maximum operating pressure of 1 MPa, and θ-ring random packing was filled inside the column; the absorption column 507 has several temperature sensors 511 provided at the bottom, body, and top, respectively, to monitor the temperature at corresponding locations; the top of the absorption column 507 was also provided with an infrared CO₂ monitor 505 at the outlet of the absorption column to monitor the CO₂ concentration in the mixed gas exiting the absorption column.

The outlet of the bottom of the absorption column 507 was connected to the inlet of the top of the desorption column 508, and the connecting pipeline between the two was sequentially provided with a pressure transmitter 514, a drain valve, and a centrifugal pump 509; wherein the pressure transmitter was used to measure the pressure of the rich solution exiting the bottom of the absorption column 507, and the drain valve was used to discharge the slurry inside the absorption column 507.

The desorption column 508 has an inner diameter of 66 mm, a packing height of 2.5 m, and a maximum operating pressure of 0.5 MPa, and θ-ring random packing was filled inside the column. The upper and middle sections of the desorption column 508 were provided with electric heating for heat preservation, with a heating power of 1 kW. Several temperature sensors 511 were provided at appropriate locations in the desorption column 508 to monitor the temperature at corresponding locations.

The inlet of the top of the desorption column 508 was connected to the inlet of liquid ring vacuum pump 506 to provide vacuum operating condition for the desorption column 508; the outlet of the desorption column 508 was provided with a drain valve, and this outlet was connected to the inlet of the metering pump 513, and a liquid filling tank 510 was provided within the connecting pipeline between the two; the liquid filling tank 510 was used to inject the capturing solution into the absorption column before the experiment began and to replenish fresh capturing solution, while the metering pump 513 was used to inject the capturing solution from the desorption column into the absorption column.

The outlet of the metering pump 513 was connected to the inlet of the top of the absorption column 507, and the connecting pipeline between the two was sequentially provided with a mass flow meter 512 and a metering pump 513; wherein the mass flow meter 512 was used to measure the flow rate of the capturing solution.

After desorption was completed in the desorption column 508, the lean solution was returned to the absorption column 507 through the metering pump 513; after multiple cycles, the absorbent achieved the separation of the CO₂/N₂ mixture.

The example also investigated the effect of desorption temperature on separation, and the specific results were shown in Table 3.

TABLE 3

| | T_{de} | φ | P_{ab} | P_{de} | U_{in-gas} | C_{in-CO2} | C_{out-CO2} | ΔS_{V} | η |
|---|---|---|---|---|---|---|---|---|---|
| No. | (K) | (V/V) | (MPa) | (MPa) | (L/h) | (mol %) | (mol %) | (mol/L) | (%) |
| 1 | 343.15 | 50 | 0.6 | 0.08 | 640 | 45 | 4.58 | 0.94 | 94.13 |
| 2 | 348.15 | 50 | 0.6 | 0.08 | 640 | 45 | 2.70 | 0.97 | 96.61 |
| 3 | 353.15 | 50 | 0.6 | 0.08 | 640 | 45 | 1.37 | 0.99 | 98.30 |
| 4 | 343.15 | 50 | 0.6 | 0.07 | 640 | 45 | 3.45 | 0.96 | 95.63 |
| 5 | 343.15 | 50 | 0.6 | 0.06 | 640 | 45 | 2.50 | 0.97 | 96.87 |

### In Table 3:

T_{de} represents the desorption temperature, q represents the gas-liquid ratio, P_{ab} represents the absorption pressure, P_{de} represents the desorption pressure, U_{in-gas} represents the flow rate of the mixed gas, C_{in-CO2} represents the CO₂ concentration at the inlet of the absorption column, C_{out-CO2} represents the CO₂ concentration at the outlet of the absorption column, ΔS_{V} represents the cycle absorption amount, and n represents the CO₂ removal rate.

From the data in Table 3, it can be seen that CO₂ adsorption separation can be well achieved with the technical solution of the present disclosure.

1. A mesh-shaped porous CO₂-capturing solution, comprising 1%-50% of a specific chemical agent, and 50%-99% of water, with respect to 100% of the total mass of the capturing solution;
wherein the specific chemical agent is one or a combination of two or more of an imidazole-based substance, an imidazole-based ionic liquid, a piperazine-based substance, and an alcohol amine-based substance;
wherein the imidazole-based ionic liquid includes one or a combination of two or more of 1-butyl-3-methyl imidazolium tetrafluoroborate, 1-hexyl-3-methyl imidazolium tetrafluoroborate, 1-hexyl-3-methyl imidazolium hexafluorophosphate, 1-ethyl-3-methyl imidazolium chloride, and 1-ethyl-3-methyl imidazolium bis(trifluoromethanesulfonyl)imide;
wherein the alcohol amine-based substance includes one or a combination of two or more of 2-amino-2-methyl-1-propanol, hydroxyethyl ethylenediamine, and triethanolamine; and
wherein the specific chemical agent forms a mesh-shaped porous structure in water.

2. (canceled)

3. The capturing solution according to claim 1, wherein the imidazole-based substance includes one or a combination of two or more of imidazole, 2-methyl imidazole, 1-methyl imidazole, 2-ethyl imidazole, 1,2-dimethyl imidazole, 2-ethyl-4-methyl imidazole, and 2-phenylimidazole.

4. (canceled)

5. The capturing solution according to claim 1, wherein the piperazine-based substance includes one or a combination of two or more of piperazine, 1-(2-aminoethyl) piperazine, N-(2-hydroxyethyl) piperazine, 1-methyl piperazine, and 2-methyl piperazine.

6. (canceled)

7. A method for separating CO₂ gas, which includes capturing CO₂ by utilizing the mesh-shaped porous CO₂-capturing solution according to claim 1.

8. The method according to claim 7, which separates CO₂ from a mixed gas of CO₂ and N₂.

9. The method according to claim 7, wherein CO₂ is captured at an absorption temperature of 0° C. to 50° C.

10. The method according to claim 7, wherein CO₂ is captured at an absorption pressure of 0.1 MPa to 1 MPa.

11. The method according to claim 7, further including a step of desorbing a CO₂-rich solution, which is obtained after CO₂ is captured, under vacuum and heating conditions, followed by regenerating a lean solution for reuse.

12. The method according to claim 11, wherein the heating is carried out at a temperature of 60° C. to 100° C.

13. The method according to claim 11, wherein the vacuum has an absolute pressure of 80 kPa or less.
